(19) United States
(12) Patent Application Publication
(10) Pub. No.: US 2009/0091585 A1
(43) Pub. Date: Apr. 9, 2009

(54) SCREEN ENLARGEMENT/REDUCTION DEVICE

(75) Inventor: Yukio Koyanagi, Saitama (JP)

Correspondence Address: CONNOLLY BOVE LODGE & HUTZ LLP, 1875 EYE STREET, N.W., SUITE 1100, WASHINGTON, DC, 20006, US

(73) Assignee: Neuro Solution Corp., Setagaya-ku, Tokyo (JP)

(21) Appl. No.: 12/281,792

(22) PCT Filed: Sep. 28, 2006
(86) PCT No.: PCT/JP2006/319907

§ 371 Date: Sep. 5, 2008

(30) Foreign Application Priority Data
Mar. 7, 2006 (JP) 2006-060973

(51) Int. Cl. G09G 5/00

(52) U.S. Cl. 345/660

(57) ABSTRACT

A screen enlargement and reduction device includes: a coefficient calculation unit (2) for obtaining a coefficient corresponding to a pixel value of each pixel of an original image and storing the coefficient in a coefficient RAM (4) for each interpolation position set in accordance with an enlargement and reduction ratio “s”; and a coefficient multiplication unit (6) for obtaining a pixel value of each pixel at the interpolation position by multiplying/adding a pixel value of each pixel of the original image extracted by a matrix decomposition unit (5) in accordance with a second process clock (cs2) generated by a clock generation unit (1) and a coefficient read out from the coefficient memory (4) in accordance with a first process clock (cs1). When actually performing an interpolation calculation, the device can be used only by reading out a necessary coefficient from the coefficient RAM (4). The device eliminates the need of calculating a coefficient upon interpolation calculation and the need of use of a large image memory for performing an interpolation calculation.

### TECHNICAL FIELD

The present invention relates to a screen enlargement and reduction device, and in particular, is suitably used for a device of performing enlargement and reduction of a digital image.

### BACKGROUND ART

Heretofore, as a way to perform enlargement or reduction of an image by simple processing, a method of repeating or thinning the same pixel at a predetermined interval is known. For example, it is possible to obtain 1.2 times of enlarged image simply by inserting a pixel, which has the same pixel value as a 5th pixel, every 5 pixels in each of an x direction and a Y direction. On the contrary, it is possible to obtain 0.8 times of reduced image simply by deleting 1 pixel every 5 pixels.

However, when a pixel is inserted or thinned in a regular interval in this way, there is a defect that an image after enlargement or reduction is distorted. Therefore, when performing enlargement and reduction of an image with high precision, a method using interpolation processing not having such a defect is used widely (for example, refer to patent document 1: Japanese Patent Laid-Open No. 11-353473). Among them, an image scaling system including combination of resampling processing and interpolation processing also exists (for example, refer to patent document 2: Japanese Patent Laid-Open No. 9-259265).

A technique described in the above-mentioned patent document 2 first of all performs resampling at 1/s times of interval to a pixel interval of an original image, for example, in the case of processing of enlarging or reducing an image into s times of one. Thereby, in comparison to a pixel count of an original image, the number of resampled points becomes s times in both of the vertical and horizontal directions. Next, pixel values of the resampled points are obtained by interpolation calculation using pixel values of the original image near the resampled points. Then, an enlarged image (or reduced image) is obtained by drawing the pixel values of the resampled points, which are obtained, at the same original pixel intervals as those of the original image.

Since it is difficult to improve performance of both of calculation speed and image quality in interpolation processing, in order to perform scaling processing at high speed with maintaining image quality, the invention of patent document 2 improves resampling processing to attain acceleration. That is, it is made to be able to calculate positions at high speed in memory, in which pixel values of pixels near the resampled points are stored, by not passing through process of obtaining resampling coordinates, but using means of obtaining directly addresses and bit numbers of neighborhood pixels which should be referred to in the interpolation processing.

### DISCLOSURE OF THE INVENTION

Nevertheless, in a conventional technique described in the above-mentioned patent document 2, there was a problem of still taking much time in interpolation processing since acceleration of the interpolation processing itself was not attained although pixel value readout of an original image used for the interpolation processing was accelerated. In addition, in performing interpolation processing, there was also a problem that circuit scale became large since a large image memory was needed in an input side and an output side of a processing unit respectively.

The present invention is made in order to solve such problems, and aims at being able not only to make circuit scale small but also to accelerate operations of scaling processing as a whole.

In order to solve the above-mentioned issues, the present invention finds a coefficient to a pixel value of each pixel of an original image around an interpolation position on the basis of a predetermined interpolation function for every interpolation position which is set according to predetermined magnification, and stores it in coefficient memory beforehand. Then, it is made in the case of image processing to perform enlargement and reduction processing of an image by obtaining a pixel value of each pixel at an interpolation position by performing multiplication and addition of a pixel value of each pixel of the original image around an interpolation position and a coefficient read at from the coefficient memory.

According to the present invention configured as described above, since a coefficient required to obtain a pixel value of an interpolation position by an interpolation calculation is beforehand stored in coefficient memory and it is possible to use it only by reading it from the coefficient memory in the case of an actual interpolation calculation, it is not necessary to calculate the coefficient in the case of the interpolation calculation, and hence, it is possible to accelerate an operation of enlargement/reducing processing of an image. In addition, it also becomes unnecessary to use a large image memory in order to perform interpolation processing, and hence, it is possible to make circuit scale of a device small.

### BRIEF DESCRIPTION OF THE DRAWINGS

FIG. 1 is a diagram showing a configuration example of a screen enlargement and reduction device according to a first embodiment;

FIG. 2 is a drawing for describing a unit matrix and a data generation area which are used in the first to a fourth embodiments;

FIG. 3 is a drawing for describing a clock cycle used in the first to fourth embodiments;

FIG. 4 is a graph showing an example of an interpolation function used in the first to fourth embodiments;

FIG. 5 is a diagram showing a configuration example of a screen enlargement and reduction device according to a second embodiment;

FIG. 6 is a diagram showing a detailed configuration example of a clock generation unit, a matrix decomposition unit, and D-type flip-flops according to the second embodiment;

FIGS. 7(a) and 7(b) are charts showing capture timing of image signals in the second embodiment;

FIG. 8 is a diagram showing a configuration example of a screen enlargement and reduction device according to a third embodiment;

FIG. 9 is a timing chart showing each clock used in a coefficient multiplication unit according to the third embodiment;

FIG. 10 is a diagram showing a configuration example of the coefficient multiplication unit used in the third embodiment;

FIG. 11 is a diagram showing a configuration example of a screen enlargement and reduction device according to a fourth embodiment;

FIG. 12 is a diagram showing a configuration example of a vertical coefficient multiplication unit used in the fourth embodiment;

FIG. 13 is a timing chart showing each clock used in a coefficient multiplication unit according to the fourth embodiment; and

FIG. 14 is a diagram showing a configuration example of a horizontal coefficient multiplication unit used in the fourth embodiment.

### BEST MODE FOR CARRYING OUT THE INVENTION

### First Embodiment

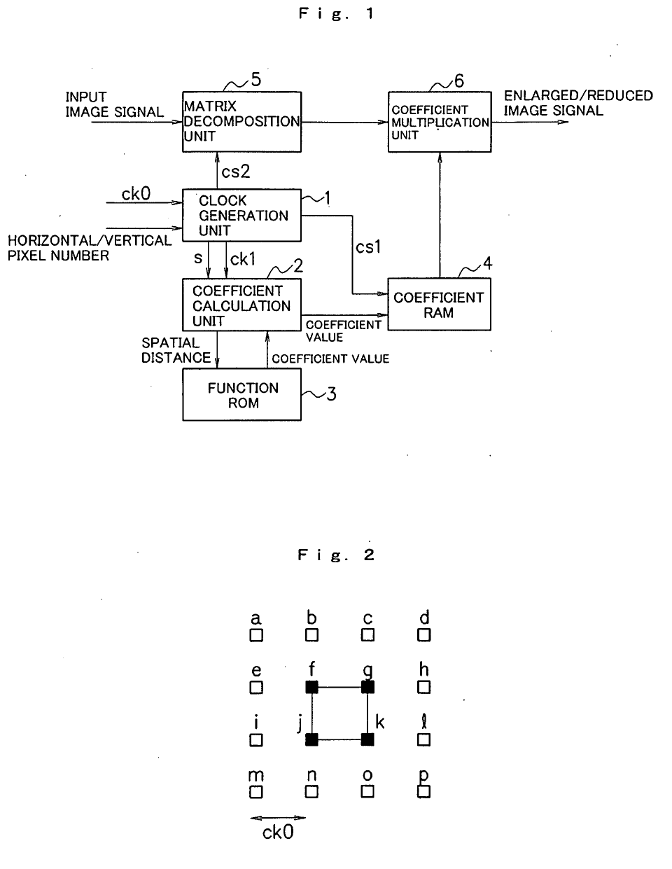

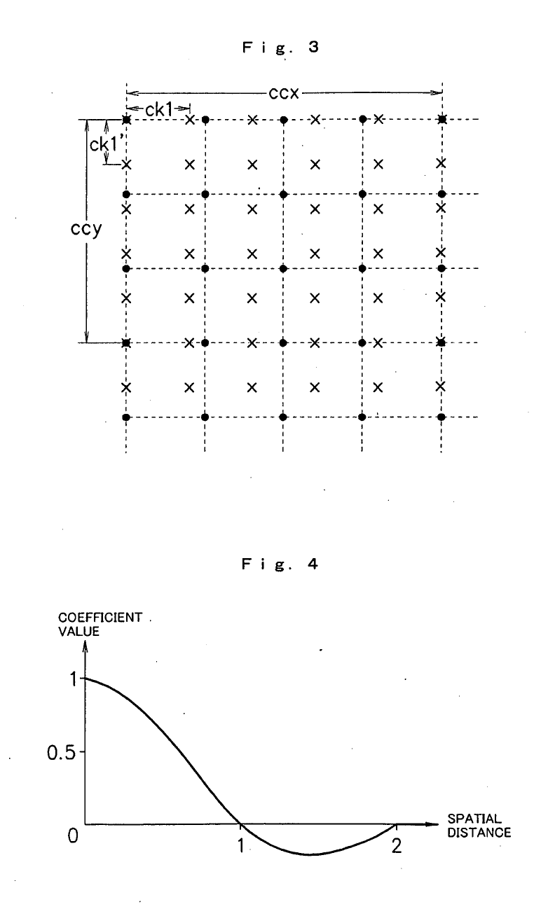

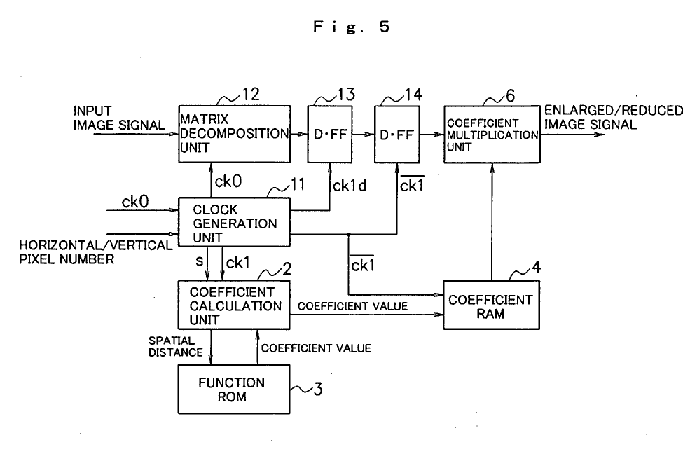

An embodiment of the present invention will be described below on the basis of drawings. FIG. 1 is a diagram showing a configuration example of a screen enlargement and reduction device according to a first embodiment. FIG. 2 is a drawing for describing a unit matrix and a data generation area which are used in the first to a fourth embodiments. FIG. 3 is a drawing for describing a clock cycle used in the first to fourth embodiments. FIG. 4 is a graph showing an example of an interpolation function used in the first to fourth embodiments.

A unit matrix is a minimum pixel block for performing scaling processing of an image, and FIG. 2 shows an example of its configuration. In FIG. 2, 16 pixels (4V×4H) “a” to “p” shown by squares are component pixels of a unit matrix. A clock interval between horizontal adjacent pixels is ck0, and a clock interval between vertical adjacent pixels is 1 horizontal clock. A data generation area is a square area (area mutually surrounded by four adjacent pixels f, g, j, and k) in a center section of a unit matrix, and interpolation data is generated in this data generation area.

A generation method of interpolation data is as follows. That is, according to an enlargement and reduction ratio “s” of an image, an interpolation position is set in a data generation area, and spatial distances between the set interpolation position and positions of 16 pixels “a” to “p” are calculated respectively. Then, coefficient values according to the spatial distances are obtained from a predetermined interpolation function. Furthermore, interpolation data is generated by performing multiplication of a pixel value of each of the pixels “a” to “p” and a coefficient value obtained for each of the pixels “a” to “p” respectively, and adding all of those multiplication results.

As the interpolation function used when obtaining the interpolation data, a function as shown in FIG. 4 is used, for example. The interpolation function shown in FIG. 4 is a function that a coefficient value becomes 1 when a spatial distance between an interpolation position and an original pixel position is 0, the coefficient value becomes 0 when the spatial distance concerned is 1 (corresponding to one reference clock ck0), and the coefficient value becomes 0 when the spatial distance concerned is two or more, and it is set so that the coefficient value may become a positive value when the spatial distance concerned is larger than 0 and smaller than 1, and the coefficient value may become a negative value when the spatial distance concerned is larger than 1 and smaller than 2.

As mentioned above, a unit matrix is set in a region of each 4 pixels in vertical and horizontal directions, and a data generation area is set in a center section of the unit matrix in a range of each 2 pixels in vertical and horizontal directions. Therefore, the spatial distance between an interpolation position set in the data generation area, and a position of a pixel in the external of the unit matrix becomes two or more certainly. Then, if a spatial distance is two or more when the interpolation function as shown in FIG. 4 is used, a coefficient value becomes certainly 0. Hence, a pixel value of a pixel in the external of the unit matrix does not affect interpolation data at all. Thus, all the interpolation calculations are completed only with pixel values within the unit matrix.

In addition, although the 4V×4H matrix is mentioned as an example of a unit matrix here, it is not limited to this. For example, it may be also a 3V×3H or 2V×2H matrix. In the case of the latter, a unit matrix and a data generation area coincide. Thus, when changing a setting range of a unit matrix, it is preferable also to change an interpolation function according to it.

Next, a clock cycle will be described. The clock cycle has a horizontal clock cycle ccx, and a vertical clock cycle ccy. FIG. 3 shows these clock cycles ccx and ccy. In FIG. 3, a black round mark denotes a pixel of an original image, and a × mark denotes a pixel of an interpolation picture in the case of making an image sH times horizontally and sV times vertically (sH and sV are arbitrary positive numbers. FIG. 3 shows an example of sH<sV, 1<sH<2, and 1<sV<2). In addition, each of rectangular areas shown by dotted lines and surrounded by four pixels of an original image denotes a data generation area.

To make an image sH times horizontally is corresponding to setting each interpolation position at 1/sH times of interval to a horizontal pixel interval of an original image to obtain a pixel value of the each interpolation position by an interpolation calculation, and to draw the obtained pixel value of the each interpolation position at the same original pixel interval as the original image. In other word, to obtain interpolation data of each interpolation position set at 1/sH times of interval is corresponding to performing resampling at an interval of a clock ck1 (=sH*ck0) in sH times of frequency to the reference clock ck0 to obtain the interpolation data of the resampled point.

In this case, a horizontal position of a resampled point in the data generation area shifts at 1/sH of interval every clock ck1 as shown in FIG. 3. Then, after several clocks of ck1, it coincides with an original pixel position. In the case of the example in FIG. 3, a horizontal position of a resampled point in the data generation area coincides with an original pixel position in a place (place apart by four in pixels of the original image) apart by five interpolation pixels.

In addition, to make an image sV times vertically is corresponding to setting each interpolation position at 1/sV times of interval to a vertical pixel interval of an original image to obtain a pixel value of the each interpolation position by an interpolation calculation, and to draw the obtained pixel value of the each interpolation position at the same original pixel interval as the original image. In other word, to obtain interpolation data of each interpolation position set at 1/sV times of interval is corresponding to performing resampling at an interval of a clock ck1′ (=sV*ck0) in sV times of frequency to the reference clock ck0 to obtain the interpolation data of the resampled point.

In this case, a vertical position of a resampled point in the data generation area shifts at 1/sH of interval every clock ck1′ as shown in FIG. 3. Then, after several clocks of ck1′, it coincides with an original pixel position. In the case of the example in FIG. 3, a vertical position of a resampled point in the data generation area coincides with an original pixel position in a place (place apart by three in pixels of the original image) apart by five interpolation pixels.

Each number of clocks ck1 and ck1′ included in a loop cycle until the position of the resampled point in the data generation area coincides with the original pixel position is called a clock cycle. In the case of the example in FIG. 3, the horizontal clock cycle ccx and the vertical clock cycle ccy are the same, that is, ccx=ccy=5. In addition, for simplification of a description, it will be described hereafter as a horizontal enlargement and reduction ratio sH is equal to a vertical enlargement and reduction ratio sV (sH=sV=“s”, ck1=ck1′).

Next, configuration of a screen enlargement and reduction device according to a first embodiment will be described. As shown in FIG. 1, the screen enlargement and reduction device according to the first embodiment is configured by including a clock generation unit 1, a coefficient calculation unit 2, function ROM 3, coefficient RAM 4, a matrix decomposition unit 5, and a coefficient multiplication unit 6.

The clock generation unit 1 not only inputs the reference clock ck0, but also inputs data of a horizontal pixel number and a vertical pixel number after enlargement and reduction, and generates a clock ck1 in s times of frequency. Hereafter, ck1 is called a data clock. The enlargement and reduction ratio “s” is determined by a ratio of original horizontal/vertical pixel numbers of an inputted image, and horizontal/vertical pixel numbers after the enlargement and reduction which are inputted into the clock generation unit 1. Although information on the enlargement and reduction ratio “s” itself may be inputted into the clock generation unit 1, depending on a value of the enlargement and reduction ratio “s”, a fraction may arise in the horizontal/vertical pixel number after the enlargement and reduction, and its processing becomes complicated. Therefore, it is preferable to input the horizontal/vertical pixel number after the enlargement and reduction into the clock generation unit 1, and to convert it into the enlargement and reduction ratio “s”.

In addition, the clock generation unit 1 generates two process clocks cs1 and cs2. The first process clock cs1 is a clock corresponding to a read address of the coefficient RAM 4, and the second process clock cs2 is a clock for controlling delay quantity of an input image signal. Details of these process clocks cs1 and cs2 will be mentioned later.

The coefficient calculation unit 2 calculates 16 coefficients for pixel values of respective pixels “a” to “p” respectively every interpolation position set according to the enlargement and reduction ratio “s” on the basis of data of the enlargement and reduction ratio “s” and the data clock ck1 which are generated by the clock generation unit 1, and data of the interpolation function which is as shown in FIG. 4 and is stored in the function ROM 3. Here, the coefficient calculation unit 2 does not need to calculate coefficients about a whole region of the original image, but what is necessary is just to obtain coefficients in one region (hereafter, this is called a clock cycle area) surrounded by the one horizontal clock cycle ccx and the one vertical clock cycle ccy.

That is, the coefficient calculation unit 2 obtains a plurality of interpolation positions which exists in the clock cycle area first. Then, spatial distances between with positions of the 16 pixels “a” to “p”, which configures a unit matrix, for the plurality of interpolation positions are calculated respectively. Furthermore, the coefficient calculation unit 2 obtains 16 coefficient values according to the spatial distance between with the positions of the respective pixels “a” to “p” for the plurality of interpolation positions with reference to the function ROM 3, respectively.

The function ROM3 stores beforehand data of the interpolation function as shown in FIG. 4. The data of the interpolation function is configured of table information that the spatial distance and the coefficient value are associated and stored, for example. In addition, although such configuration is adopted that the coefficient calculation unit 2 reads the coefficient value associated with the spatial distance with reference to the table information of the function ROM 3 on the basis of the spatial distance concerned here, it is not limited to this. For example, instead of providing the function ROM 3 which has table information, a coefficient value may be obtained by operation by substituting a spatial distance into a formula expressing an interpolation function, as shown in FIG. 4, as a parameter.

The coefficient RAM 4 stores coefficients obtained by the coefficient calculation unit 2. It is possible to store beforehand coefficients according to various values of the enlargement and reduction ratio “s” in the coefficient RAM 4 by setting several values of the enlargement and reduction ratio “s” of an image and obtaining coefficients by the coefficient calculation unit 2. Capacity of the coefficient RAM4 becomes (product of the horizontal clock cycle ccx and vertical clock cycle ccy)×16×2 [words] per processed image system.

For example, let the enlargement and reduction ratio “s” be 0.5 to 4 and let its pitch be 0.1, and both maximums of horizontal and vertical clock cycles become 39, and hence, the capacity of the coefficient RAM 4 required in order to enlarge/reduce three systems, that is, R color, G color, and B color of images becomes 39²×16×6≈146 KWords at the maximum. In addition, let a pitch of the enlargement and reduction ratio “s” be 0.2, and both maximums of horizontal and vertical clock cycles become 19, and hence, the capacity of the coefficient RAM 4 becomes 19²×16×6≈35 KWords at the maximum. In addition, let the pitch of the enlargement and reduction ratio “s” be 0.5, and both maximums of horizontal and vertical clock cycles become 7, and hence, the capacity of the coefficient RAM 4 becomes 7²×16×6≈5 KWords at the maximum. Anyway, only the small capacity is sufficient.

In addition, as mentioned above, although the coefficient calculation unit 2 obtains 16 coefficient values according to the spatial distance between with the positions of 16 pixels “a” to “p”, which configure a unit matrix, for one interpolation position to store them in the coefficient RAM 4, it is not limited to this. In the 16 pixels “a” to “p”, a plurality of ones which has the same spatial distance in view of one interpolation position may exist. In regard to pixels with the same spatial distance between with an interpolation position, only one coefficient value may be obtained representatively to store it in the coefficient RAM 4. When doing so, it is possible to further lessen the capacity of the coefficient RAM 4.

The matrix decomposition unit 5 extracts pixel values of the 16 pixels “a” to “p”, which configure the unit matrix, from an input image signal. At this time, the matrix decomposition unit 5 controls delay quantity (movement of a data generation area) of the input image signal on the basis of the second process clock cs2 supplied from the clock generation unit 1. The second process clock cs2 is generated by the clock generation unit 1 using the reference clock ck0, enlargement and reduction ratio “s” of an image, and clock cycles ccx and ccy.

As described in FIG. 3, the number of interpolation positions included in one clock cycle, differs according to the enlargement and reduction ratio “s” of an image. In addition, depending on the enlargement and reduction ratio “s”, the number of the interpolation positions included in data generation area may change every data generation area included in a clock cycle. In the example shown in FIG. 3, among four data generation areas included in the horizontal clock cycle ccx, although the horizontal interpolation position is two in first and fourth data generation areas, the horizontal interpolation position is only one in second and third data generation areas.

Then, as mentioned later, when obtaining interpolation data in the coefficient multiplication unit 6, it is necessary to obtain each two interpolation data in the first and fourth data generation areas, and to obtain each one interpolation data in the second and third data generation areas. That is, it is necessary to move the first and fourth data generation areas horizontally in the timing of counting two clocks of the data clock ck1, and to move the second and third data generation areas horizontally in the timing of counting one clock of the data clock ck1. A clock for controlling such movement of a data generation area is the second process clock cs2.

The coefficient multiplication unit 6 generates interpolation data at one interpolation position by multiplying each pixel value of the pixels “a” to “p” within the unit matrix outputted from the matrix decomposition unit 5, and each coefficient value (each coefficient value for pixels “a” to “p”) read from the coefficient RAM 4 respectively, and adding all of those multiplication results. This processing is performed about all the interpolation positions for an original image with moving sequentially the unit matrix by the matrix decomposition unit 5. In this embodiment, interpolation data is obtained sequentially by one horizontal line from a top line of the original image towards a lowest line.

Here, readout of a coefficient value from the coefficient RAM 4 is controlled by the first process clock cs1 outputted from the clock generation unit 1. Specifically, the same coefficients are read out repeatedly from the coefficient RAM 4 in a cycle of the horizontal clock cycle ccx until processing finishes about one horizontal line. That is, after five sets of coefficients (one set is configured of coefficient values for 16 pixels “a” to “p”) for five interpolation positions from the left, which are included in the horizontal clock cycle ccx shown in FIG. 3, are read out from the coefficient RAM 4 sequentially, the same five sets of coefficients are again read out sequentially from the coefficient RAM 4.

When one horizontal line corresponding of processing finishes, the interpolated line is moved only by 1/s vertically, and five sets of coefficients for the next horizontal line are read out sequentially from the coefficient RAM 4. Also at this time, the same five sets of coefficients are read out repeatedly in a cycle of the horizontal clock cycle ccx until one horizontal line corresponding of processing finishes. Processing is repeated similarly hereafter, and in a phase of the vertical clock cycle ccy also taking a round, all the coefficients stored in the coefficient RAM 4 are read out wholly once. After that, it returns to a top of the coefficient RAM4 again, and the coefficients are read out in a similar manner.

The coefficient multiplication unit 6 generates interpolation data at each interpolation position by multiplying/adding a coefficient value read out from the coefficient RAM 4 one by one as described above and a pixel value of each of the pixels “a” to “p” within a unit matrix outputted while controlling a movement by the matrix decomposition unit 5 respectively. Then, it outputs a plurality of generated interpolation data at the same original interval of the reference clock ck0 as that of the original image.

Next, operations of the screen enlargement and reduction device according to this embodiment configured as the above will be described. The screen enlargement and reduction device of this embodiment operates in two stages of a creation and storage stage of a coefficient, and an enlargement and reduction phase of an image. In the creation and storage stage of a coefficient, the clock generation unit 1, coefficient calculation unit 2, function ROM 3, and coefficient RAM 4 are used. In the enlargement and reduction phase of an image, the clock generation unit 1, coefficient RAM 4, matrix decomposition unit 5, and coefficient multiplication unit 6 are used.

In the creation and storage stage of a coefficient, the clock generation unit 1 generates the data clock ck1 (=s*ck0) on the basis of the reference clock ck0 and enlargement and reduction ratio “s” to supply it to the coefficient calculation unit 2. The coefficient calculation unit 2 calculates a plurality of coefficients for pixel values of respective pixels “a” to “p” respectively every interpolation position set according to the enlargement and reduction ratio “s” on the basis of the enlargement and reduction ratio “s”, data clock ck1, and data of the interpolation function stored in the function ROM 3 as shown in FIG. 4. Then, the plurality of calculated coefficients is stored and saved in the coefficient RAM 4.

At this time, a unit matrix is first set at a most upper left position of the original image, and a plurality of interpolation positions is obtained in the data generation area located in a center of the unit matrix. Then, 16 coefficients for the pixel values of respective pixels “a” to “p” which configure the unit matrix concerned are calculated about the interpolation positions respectively.

Next, the unit matrix is horizontally moved by 1 pixel, and coefficients are similarly calculated about the data generation area within the unit matrix after movement. Hereafter, similarly, coefficients are calculated by moving the unit matrix by 1 pixel at a time horizontally. Then, when processing for the one horizontal clock cycle ccx is finished, the unit matrix is set in the leftmost of the next horizontal line.

Also about the next horizontal line, the same processing as that for the first horizontal line is performed. Hereafter, similarly, such a processing is repeatedly performed, and when the processing is finished to the one vertical clock cycle ccy, creation of coefficients is completed. The coefficient calculation unit 2 stores in the coefficient RAM 4 the plurality of coefficients, obtained in process of the above processing, one by one.

In addition, in the enlargement and reduction phase of an image, the clock generation unit 1 generates process clocks cs1 and cs2 on the basis of the reference clock ck0 and enlargement and reduction ratio “s”, and supplies the first process clock cs1 to the coefficient RAM 4, and the second process clock cs2 to the matrix decomposition unit 5.

The matrix decomposition unit 5 extracts pixel values of the 16 pixels “a” to “p”, which configure the unit matrix, from an input image signal. At this time, the matrix decomposition unit 5 sets a unit matrix by one horizontal line at a time in order from the most upper left position of the original image toward a most lower right position. At this time, the matrix decomposition unit 5 properly controls horizontal and vertical movements of the unit matrix in accordance with the second process clock cs2.

The coefficient multiplication unit 6 obtains interpolation data one by one at one or more interpolation positions which exist in the data generation area within the unit matrix set by the matrix decomposition unit 5. Interpolation data at one interpolation position is generated by multiplying pixel values of the 16 pixels “a” to “p” which configure the unit matrix, and 16 coefficient values read out from the coefficient RAM 4 for those respective pixels “a” to “p” respectively, and adding all of those multiplication results.

Operations of the matrix decomposition unit 5 and coefficient multiplication unit 6 will be described a little more specifically. First, the matrix decomposition unit 5 sets a unit matrix at a most upper left position of the original image, and extracts pixel values of respective 16 pixels “a” to “p”. In addition, the coefficient multiplication unit 6 obtains an interpolation position in the data generation area of the unit matrix. Then, about the interpolation position, interpolation data is generated by reading out coefficients for the interpolation position concerned from the coefficient RAM 4 and multiplying/adding these read out coefficient values and pixel values of respective pixels “a” to “p” of the unit matrix.

Next, the unit matrix is horizontally moved by 1 pixel, and similarly, interpolation data is obtained. Thus, the coefficient multiplication unit 6 sequentially creates a plurality of interpolation data related to a first interpolated line. At this time, the matrix decomposition unit 5 properly controls a horizontal movement of the unit matrix in accordance with the second process clock cs2. In addition, the coefficient multiplication unit 6 repeatedly reads out coefficients corresponding to each interpolation position from the coefficient RAM 4 in accordance with the first process clock cs1 in the cycle of the horizontal clock cycle ccx.

When one horizontal line corresponding of processing is completed, the matrix decomposition unit 5 returns the position of the unit matrix to the top (leftmost position) on the horizontal line. At this time, the matrix decomposition unit 5 properly controls a vertical movement of the unit matrix in accordance with the second process clock cs2. For example, in the case of the example in FIG. 3, since the second interpolated line exists in the same data generation area as the first interpolated line, the unit matrix is not moved vertically. Thus, the same data generation area at the time of processing the first interpolated line is used also for the second interpolated line.

Here, completion of one horizontal line corresponding of processing can be made to be, for example, timing when a unit matrix is set at a rightmost position of the original image and creation of interpolation data is finished. In addition, when enlargement and reduction of an image is performed on the basis of an upper left position of an original image, when enlarging the image, one horizontal line corresponding of processing may be completed in a phase of obtaining the same number of interpolation data as a horizontal pixel count of the original image. In the case of the latter, one horizontal line corresponding of processing is completed without setting a unit matrix to the rightmost position of the original image.

Then, the coefficient multiplication unit 6 generates a plurality of interpolation data related to a second interpolated line by now reading out coefficients for an interpolation position of the second interpolated line sequentially from the coefficient RAM 4, and multiplying/adding these read out coefficient values and pixel values of respective pixels “a” to “p” of a unit matrix. At this time, the matrix decomposition unit 5 properly controls a horizontal movement of the unit matrix in accordance with the second process clock cs2. In addition, the coefficient multiplication unit 6 repeatedly reads out coefficients corresponding to each interpolation position from the coefficient RAM 4 in accordance with the first process clock cs1 in the cycle of the horizontal clock cycle ccx.

Hereafter, the processing is similarly advanced about third and following interpolated lines. At this time, the coefficient multiplication unit 6 repeatedly reads out coefficients corresponding to each interpolation position from the coefficient RAM 4 in accordance with the first process clock cs1 in the cycle of the horizontal clock cycle ccx in a horizontal direction, and repeatedly reads them out from the coefficient RAM 4 in the cycle of the vertical clock cycle ccy in a vertical direction.

Then, in the timing when a unit matrix is set at a rightmost lower position of the original image and creation of interpolation data finished, creation of all the interpolation data is completed. In addition, when enlargement and reduction of an image is performed on the basis of an upper left position of an original image, when enlarging the image, creation of interpolation data may be completed in a phase of obtaining the same number of interpolation data as a vertical pixel count of the original image in the vertical direction. In the case of the latter, the processing is completed without setting a unit matrix to a lowest position of the original image.

In addition, in the case of the former method of obtaining an enlarged/reduced image with making a whole original image an object, when it is an enlarged image, it becomes possible to cut an arbitrary position in the enlarged image and to output it on a screen. Nevertheless, in this case, an output buffer for storing the enlarged image data is needed. On the other hand, in the case of the latter method of obtaining only the same number of interpolation data as the pixel count of the original image, since it is not necessary to obtain interpolation data at useless pixel positions which are not outputted on a screen, it is possible to further accelerate the enlargement/reducing process. In addition, an output buffer is also unnecessary.

The coefficient multiplication unit 6 outputs the plurality of interpolation data, obtained as mentioned above, at the same original interval of the reference clock ck0 as that of the original image. At this time, when adopting a method of obtaining interpolation data about a full region of the original image, storing it in an output buffer, and cutting and outputting an arbitrary region, interpolation data in the cut-out region is outputted sequentially at the interval of the reference clock ck0. On the other hand, when adopting a method of obtaining only the same number of interpolation data as the pixel count of the original image on the basis of the upper left position of the original image, and outputting it, what is necessary is just to output the interpolation data, generated by the coefficient multiplication unit 6, at the interval of the reference clock ck0 with keeping the order.

As described above in detail, according to the first embodiment, since it is possible to store coefficients, required to obtain interpolation data by interpolation calculation, beforehand in the coefficient RAM 4, and to use them in the case of an actual interpolation calculation only by reading them out from the coefficient RAM 4, it is not necessary to calculate the coefficients in the case of the interpolation calculation, and hence, it is possible to accelerate the interpolation processing. In addition, it is possible to eliminate necessity of using a large image memory in order to perform interpolation processing. In particular, when adopting a method of obtaining only the same number of interpolation data as the pixel count of the original image, what is necessary is just to output the interpolation data, generated by the coefficient multiplication unit 6, at the interval of the reference clock ck0 with keeping the order, and hence, real-time processing is possible, and an output buffer is also unnecessary.

In addition, in the above-mentioned embodiment, although the example of obtaining interpolation data in order every horizontal line from the top end toward the lower end in an enlargement and reduction phase of the original image is described, it is not limited to this. For example, interpolation data may be obtained in order every vertical line from the left end toward the right end of the original image. In addition, horizontal and vertical interpolation data may be obtained in order every data generation area.

### Second Embodiment

Next, a second embodiment of the present invention will be described with reference to drawings. FIG. 5 is a diagram showing a configuration example of a screen enlargement and reduction device according to the second embodiment. In addition, in this FIG. 5, since those given the same reference numerals as the reference numerals shown in FIG. 1 have the same features, their duplicated description will be omitted. As shown in FIG. 5, the screen enlargement and reduction device according to the second embodiment is configured by including a clock generation unit 11, a matrix decomposition unit 12, D-type flip-flops 13 and 14, the coefficient calculation unit 2, function ROM 3, coefficient RAM 4, and the coefficient multiplication unit 6.

The clock generation unit 11 not only inputs the reference clock ck0, but also inputs data of a horizontal pixel number and a vertical pixel number after enlargement and reduction, and generates a data clock ck1 in s times of frequency, an adjustment data clock ck1d whose rise timing is finely adjusted, and an inverted data clock ck1-bar that is an inverted phase of the data clock ck1. In addition, also here, for simplification of a description, it is assumed that a horizontal enlargement and reduction ratio sH is equal to a vertical enlargement and reduction ratio sV, and both of them are “s”.

The matrix decomposition unit 12 extracts pixel values of the 16 pixels “a” to “p”, which configure the unit matrix, from an input image signal. At this time, the matrix decomposition unit 12 outputs pixel values of the respective pixels “a” to “p” in accordance with the timing of the reference clock ck0 concerned on the basis of the reference clock ck0 supplied from the clock generation unit 11. The matrix decomposition unit 12 according to the second embodiment has a simple configuration of outputting the pixel values of the respective pixels “a” to “p”, which configure a unit matrix set in the cycle of the reference clock ck0, as movement of a data generation area is not irregularly controlled by the second process clock cs2 like the first embodiment.

A first stage D-type flip-flop 13 once holds a pixel value of each of the pixels “a” to “p” outputted from the matrix decomposition unit 12 in accordance with the adjustment data clock ck1d supplied from the clock generation unit 11, and outputs it in the timing of the adjustment data clock ck1d concerned. In addition, a second stage D-type flip-flop 14 once holds a pixel value of each of the pixels “a” to “p” outputted from the first stage D-type flip-flop 13 in accordance with the inverted data clock ck1-bar supplied from the clock generation unit 11, and outputs it in the timing of the inverted data clock ck1-bar concerned.

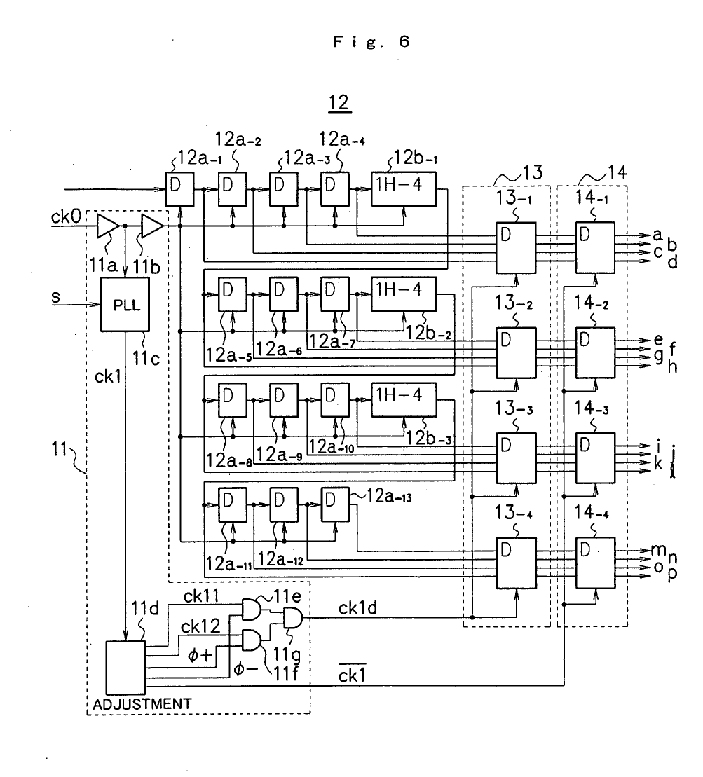

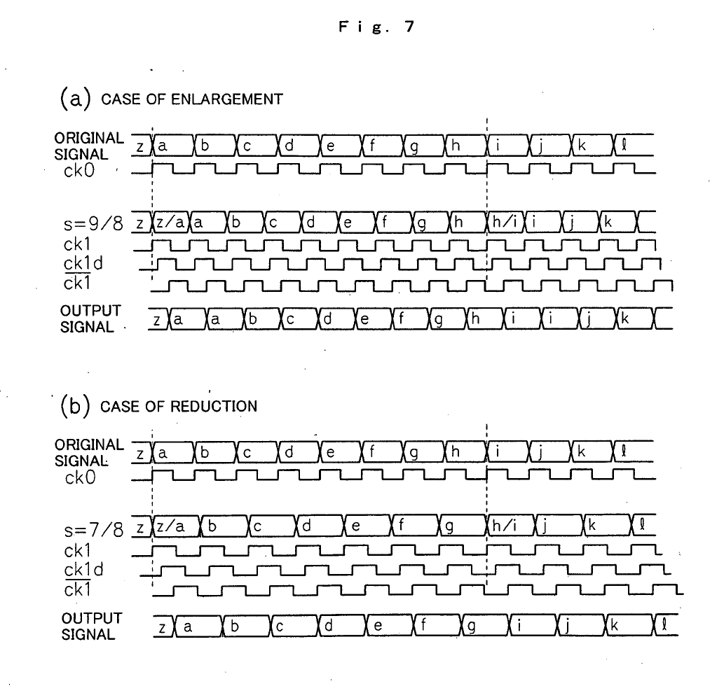

FIG. 6 is a diagram showing a detailed configuration example of the above-mentioned clock generation unit 11, matrix decomposition unit 12, and D-type flip-flops 13 and 14. As shown in FIG. 6, the clock generation units 11 comprises buffers 11a and 11b, a PLL (Phase Locked Loop) circuit 11c, a regulation circuit 11d, and AND gates 11e, 11f, and 11g.

The clock generation unit 11 outputs the reference clock ck0, inputted from the external, to the matrix decomposition unit 12 through the two buffers 11a and 11b. The PLL circuit 11c inputs the reference clock ck0, outputted from the first buffer 11a, and data of the enlargement and reduction ratio “s”, and generates the data clock ck1 in s times of frequency from the reference clock ck0. The data clock ck1 generated is supplied to the regulation circuit 11d. With collaborating with three AND gates 11e to 11g, the regulation circuit 11d generate the adjustment data clock ck1d that is obtained by finely tuning a timing of the data clock ck1, and the inverted data clock ck1-bar that is obtained by inverting a phase of the data clock ck1. Its details will be described later.

The matrix decomposition unit 12 is configured by comprising 13 D-type flip-flops 12a₋₁ to 12a₋₁₃ for delay, and three line memory 12b₋₁ to 12b₋₃ for delay each of whose capacitances is smaller by 4 pixels than one horizontal line corresponding of the original image. The D-type flip-flops 12a₋₁ to 12a₋₁₃ and line memory 12b₋₁ to 12b₋₃ for delay sequentially delays an inputted image signal in accordance with the reference clock ck0, takes out pixel values of respective pixels “a” to “p” from respective output taps, and supplies them to the first stage D-type flip-flop 13 for buffering.

The first stage D-type flip-flop 13 for buffering is configured by comprising four sets (one set is four pieces) of D-type flip-flops 13₋₁ to 13₋₄. Then, it once holds a pixel value of each of the pixels “a” to “p” outputted from the matrix decomposition unit 12 in accordance with the adjustment data clock ck1d, and outputs it to a second stage D-type flip-flop 14 for buffering in accordance with the timing of the adjustment data clock ck1d concerned.

The second stage D-type flip-flop 14 for buffering is configured by comprising four sets of D-type flip-flops 14₋₁ to 14₋₄. These D-type flip-flops 14₋₁ to 14₋₄ once hold pixel values of the respective pixels “a” to “p” outputted from the four sets of D-type flip-flops 13₋₁ to 13₋₄, which exist in the previous stage, in accordance with the inverted data clock ck1-bar, and outputs them to the coefficient multiplication unit 6 in according with the timing of the inverted data clock ck1-bar concerned.

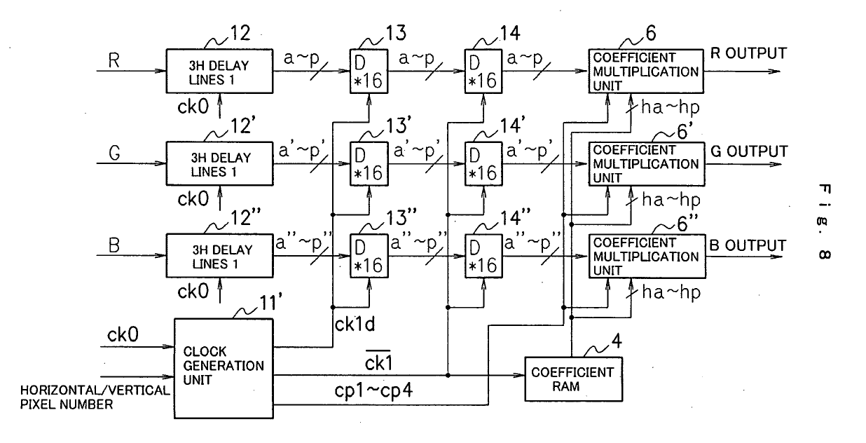

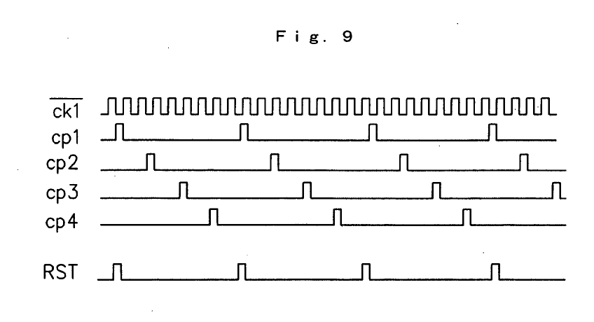

FIGS. 7(a) and 7(b) are charts showing capture timing of image signals on the basis of the above-mentioned respective data clock ck1d and ck1-bar. In addition, FIG. 7(a) shows an example in the case of enlarging an image, and FIG. 7(b) shows an example in the case of reducing an image.

As mentioned above, the D-type flip-flops 12a₋₁ to 12a₋₁₃ and line memory 12b₋₁ to 12b₋₃ for delay of the matrix decomposition unit 12 hold pixel values of the original signal in accordance with the reference clock ck0, On the other hand, the D-type flip-flops 13₋₁ to 13₋₄ for buffering perform oversampling of pixel values in accordance with a clock in s times of frequency. Nevertheless, when the pixel values are held in accordance with the data clock ck1 in s times of frequency simply, in the case that rise timing of the data clock ck1 is near changeover timing of the reference clock ck0, data may be unable to be sampled well since the original signal is on the way of changeover.

Then, using the regulation circuit 11d and AND gates 11e to 11g, it is made to be able to sample data securely by generating the adjustment data clock ck1d, which never rises by any means in the timing when the reference clock ck0 changes (rises), from the data clock ck1.

That is, the regulation circuit 11d generates a clock ck11 whose phase advances by a predetermined amount Δ than the data clock ck1, and a clock ckl2 whose phase delays by a predetermined amount Δ than the data clock ck1. Here, as the predetermined amount Δ, a time necessary for a rise of the reference clock ck0 is required, and it is preferable that it is near that time.

In addition, the regulation circuit 11d judges whether rise timing of the data clock ck1 advances or delays for a phase than exactly central timing (hereafter, this is called central timing) between a rise and a fall of the reference clock ck0, and outputs a phase advance signal φ₊ or a phase delay signal φ₋ according to the judgment result.

A first AND gate 11e takes and outputs AND of the clock ck11 whose phase advances by the predetermined amount Δ than the data clock ck1, and the phase delay signal φ₋. In addition, a second AND gate 11f takes and outputs AND of the clock ck12 whose phase delays by the predetermined amount Δ than the data clock ck1, and the phase advance signal φ₊. In addition, a third AND gate 11g takes and outputs AND of an output of the first AND gate 11e, and an output of the second AND gate 11f.

Thereby, when the phase of the data clock ck1 advances than the central timing of the reference clock ck0, a clock which delays by the predetermined amount a than the rise timing of the data clock ck1 concerned is outputted from the third AND gate 11g. On the contrary, when the phase of the data clock ck1 delays than the central timing of the reference clock ck0, a clock which advances by the predetermined amount Δ than the rise timing of the data clock ck1 concerned is outputted from the third AND gate 11g. This is the adjustment data clock ck1d.

In addition, using the data clock ck1 supplied from the PLL circuit 11c, the regulation circuit 11d generates the inverted data clock ck1-bar whose cycle is the same as that of the data clock ck1 concerned, and whose phase shifts by a half cycle from the data clock ck1. As mentioned above, the adjustment data clock ck1d has the phase of partially advancing and partially delaying by Δ than the data clock ck1, and its cycle is not constant. Hence, it is not possible to supply the pixel values buffered in the D-type flip-flop 13₋₁ to 13₋₄ in raw timing in accordance with such the adjustment data clock ck1d to the coefficient multiplication unit 6.

Then, D-type flip-flops 14₋₁ to 14₋₄ for buffering are further provided in a post-stage of the D-type flip-flops 13₋₁ to 13₋₄, and the pixel values of the respective pixels “a” to “p” are resampled according to the inverted data clock ck1-bar with a fixed cycle to be supplied to the coefficient multiplication unit 6. In addition, although the inverted data clock ck1-bar is used here, it is not limited to this. That is, it may be a clock which rises in timing, different from the changeover of the adjustment data clock ck1d, in a fixed cycle.

As described above in detail, according to the second embodiment, by an input image signal passing the matrix decomposition unit 12 and D-type flip-flops 13 and 14, the pixel values of the respective pixels “a” to “p” which configure a unit matrix are oversampled s times in accordance with the inverted data clock ck1-bar in s times of frequency according to the enlargement and reduction ratio “s”, and are outputted.

Thereby, it becomes unnecessary to control complicatedly a movement of an input image signal (data generation area) by the second process clock cs2 like the first embodiment. In addition, it is not necessary to prepare image memory for buffering in an input side of the matrix decomposition unit 12 for movement control, and hence, it is possible to further reduce circuit scale. Furthermore, since buffering for movement control is unnecessary, it is possible to further accelerate an operation of enlargement/reducing processing.

### Third Embodiment

Next, a third embodiment according to the present invention will be described on the basis of drawings. The third embodiment shows an example in the case of applying the screen enlargement and reduction device according to the above-mentioned second embodiment to NTSC-high vision system conversion (device of upsampling an NTSC system image into a high vision system).

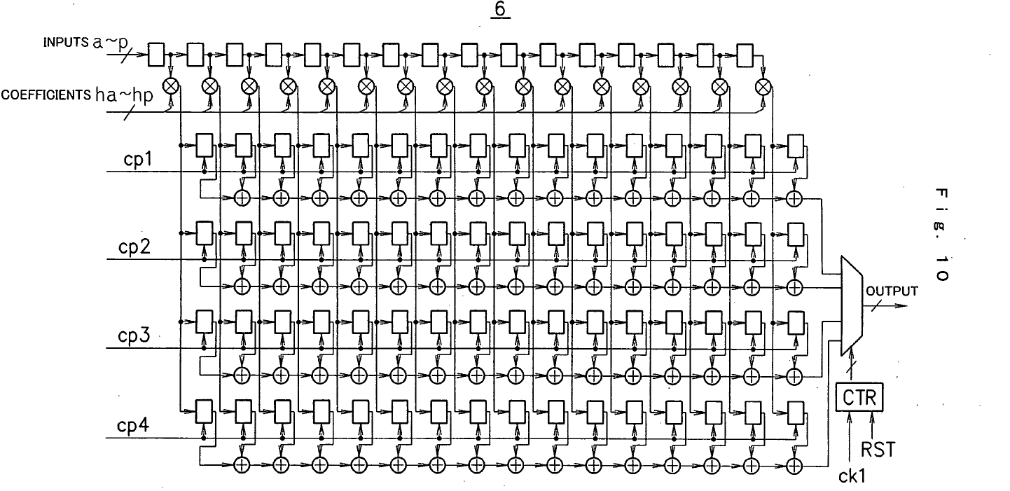

FIG. 8 is a diagram showing a configuration example of the screen enlargement and reduction device according to the third embodiment. Here, the case where both of the NTSC and Hi-Vision use interlace scanning and the same field frequency will be considered. Generally, after converting interlace scanning into sequential scanning, system conversion is performed, and then, it is returned to the interlace scanning. The configuration shown in FIG. 8 is a circuit of converting a sequential scanning input into a sequential scanning output. In addition, in FIG. 8, the same reference numerals are assigned to components having the same features as the components shown in FIGS. 5 and 6.

Here, a ratio of active scanning lines per frame of the NTSC and Hi-Vision is 480:1080, and a ratio of valid pixel numbers is 720:1920. In addition, let horizontal amplitude converted on a Hi-Vision screen be 100%, and upper and lower ends of a vertical range become out of display. In this case, the ratio of the valid pixel numbers becomes 720:1440. In addition, since a pixel is not a square pixel but 1.125:1 in the case of the NTSC, the ratio of the valid pixel numbers becomes 720:1620. Hence, a magnification from the NTSC system to the Hi-Vision system becomes horizontal magnification sH=1620/720=2.25 and vertical magnification sV=1080/480=2.25.

In FIG. 8, 3H delay lines 12, 12′, and 12″ are corresponding to the 13 D-type flip-flops 12a-l to 12a₋₁₃, and three line memories 12b₋₁ to 12b₋₃, which are shown in FIG. 6, respectively. In addition, D-type flip-flops 13, 13′, and 13″ are corresponding to the 4 sets of D-type flip-flops 13₋₁ to 13₋₄ shown in FIG. 6, respectively. In addition, D-type flip-flops 14, 14′, and 14″ are corresponding to the 4 sets of D-type flip-flops 14₋₁ to 14₋₄ shown in FIG. 6, respectively. In addition, coefficient multiplication units 6, 6′, and 6″ are corresponding to the coefficient multiplication units 6 shown in FIG. 5, respectively.

Although a clock generation unit 11′ generates the data clock ck1, adjustment data clock ck1d, and inverted data clock ck1-bar like the clock generation unit 11 shown in FIG. 6, in addition to this, generates a plurality (for example, four pieces) of clocks cp1 to cp4 for pipelines whose phases delay by a predetermined amount mutually. FIG. 9 is a chart showing timing of these clocks cp1 to cp4 for pipelines. As shown in FIG. 9, one cycle of pipeline processing is formed of these four clocks cpl to cp4 for pipelines.

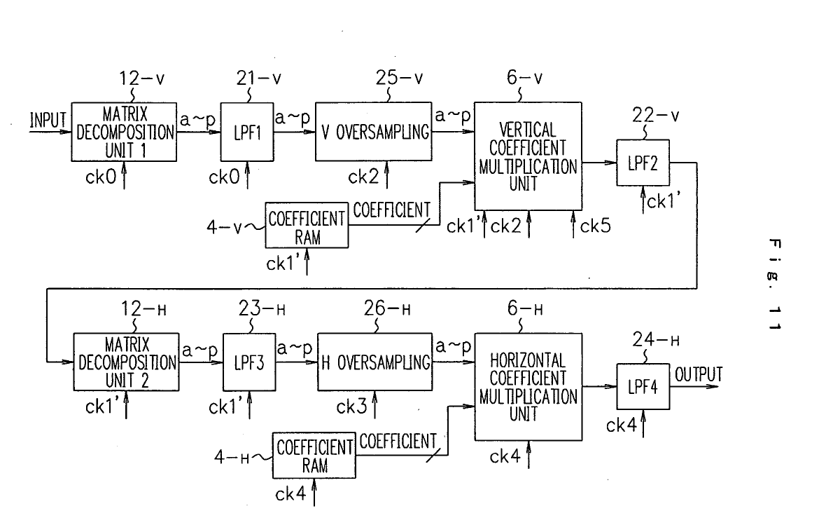

FIG. 10 is a diagram showing a configuration example of the coefficient multiplication unit 6 shown in FIG. 8. In FIG. 10, blocks shown by squares are D-type flip-flops for delay, blocks shown by × marks enclosed by rounds are coefficient multipliers, and blocks shown by + marks enclosed by rounds are adders. A CTR is a counter, and a block shown by a trapezoid is a selector. The configuration of FIG. 10 achieves a faster real-time operation by performing product sum operations of the pixel values of the respective pixels “a” to “p” inputted, and coefficient values ha to hp, read out from the coefficient RAM 4, by pipeline processing.

In addition, in the case that the screen enlargement and reduction device is configured as shown in FIG. 8 and the coefficient multiplication unit 6 therein is configured like FIG. 10, an influence of folding noise arises in a range in which the enlargement and reduction ratio “s” is 1.5 or less. In this case, conversion into a range of 1.5 or less times may be performed by making the given enlargement and reduction ratio “s” n times to perform enlargement and reduction processing of an image, and finally performing 1/n thinning processing. For example, when the enlargement and reduction ratio “s” is 1.2 times, what is necessary is just to enlarge an image with two times of magnification (“s”=2.4) of this, and to perform the ½ thinning processing of the enlarged image. If it does in this way, the influence of the folding noise is reducible.

Here, if n=2, when the enlargement and reduction ratio “s” is 0.75 or less, it cannot respond. On the other hand, when a value of “n” is increased, a clock frequency required as an operation clock becomes very high. In addition, although it is effective to make both of the horizontal enlargement and reduction ratio sH and vertical enlargement and reduction ratio sV n times, thinning processing is necessary in both of horizontal and vertical directions, and hence, a thinning circuit becomes complicated.

In order to avoid these problems, it is preferable to perform it as follows. That is, with making only a horizontal enlargement and reduction ratio sH n times, the magnification n is optimized according to a value of the enlargement and reduction ratio sH. Since processing becomes simple when the value of the magnification n is made into binary exponential, it is preferable to make n=2, 4, 8, 16, and so on. For example, it is made n=16 at the time of sH<0.4, n=8 at the time of 0.5<=sH<0.6, n=4 at the time of 0.7<=sH<0.9, and n=2 at the time of sH>=1.0.

In addition, a reason why the horizontal enlargement and reduction ratio sH is made 10 times, not vertically, q to perform enlargement and reduction processing of an image to perform horizontal 1/10 thinning processing finally is because horizontal thinning processing is more simple than vertical thinning processing. It is also possible to make a vertical enlargement and reduction ratio sH 10 times to perform enlargement and reduction processing of an image, and to perform vertical 1/10 thinning processing after that.

### Fourth Embodiment

Next, a fourth embodiment according to the present invention will be described on the basis of drawings. The fourth embodiment shows an example in the case of applying the screen enlargement and reduction device according to the above-mentioned second embodiment to enlargement and reduction of moving images. In the case of the enlargement and reduction processing of moving images, folding noise may arise by lap of a spectrum. In order to suppress generation of this folding noise, devices which are expressed hereafter are applied with regard to the enlargement and reduction processing of moving images.

Device 1: To make an enlargement and reduction ratio into a single FIGURE below a decimal point. When performing the enlargement and reduction, a given enlargement and reduction ratio is made 10 times to perform enlargement and reduction processing of images to perform 1/10 thinning processing to a final output signal. Nevertheless, when doing this way, it is required that a clock frequency to be used is very large. For example, let a maximum of an enlargement and reduction ratio be 4.0, and when a sampling frequency of an input image signal is 13.5 MHz, a necessary clock frequency becomes a GHz band (4×13.5 M×10²=5.4 GHz), and this is not realistic. The next device 2 is applied as this solution.

Device 2: To divide enlargement and reduction processing into two stages of vertical enlargement and reduction and horizontal enlargement and reduction, and to perform them. At this time, it is processed in order of a vertical direction to a horizontal direction. Then, in respective processing in the vertical and horizontal directions, the enlargement and reduction ratios sH and sV are made 10 times to perform enlargement and reduction processing of images, and to perform 1/10 thinning processing after that. In this case, a necessary clock frequency is only 10 times of the horizontal enlargement and reduction ratio sH or vertical enlargement and reduction ratio sV. When a maximum of an enlargement and reduction ratio is 4.0, a necessary clock frequency is sufficient to be 4×13.5 M×10=540 MHz.

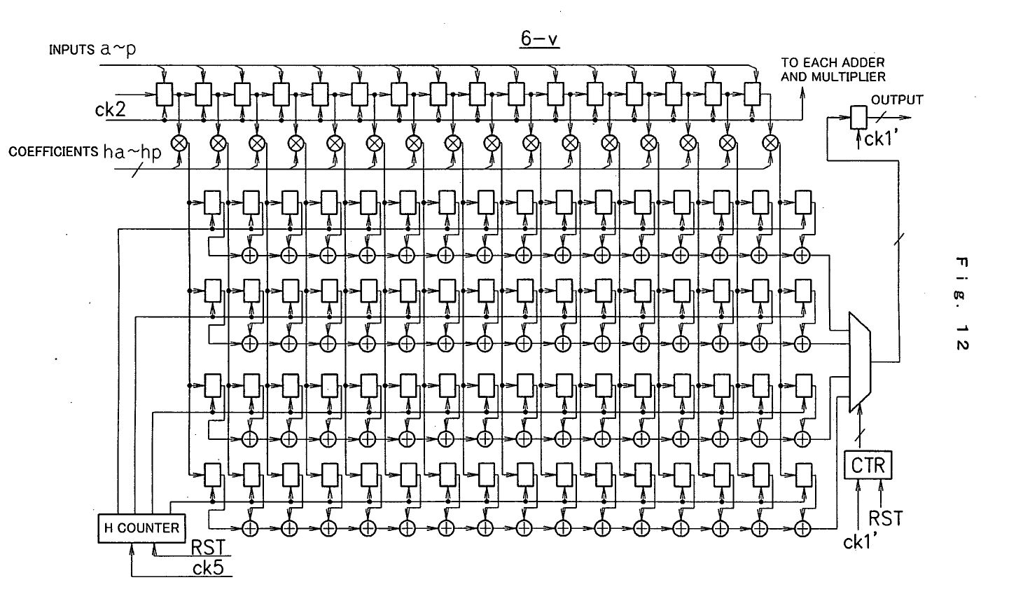

FIG. 11 is a diagram showing a configuration example of the screen enlargement and reduction device for moving images where the above-described device 1 and device 2 are applied. In FIG. 11, components to each of which reference numeral with V after a hyphen (-) is assigned are for vertical enlargement and reduction processing, and components to each of which reference numeral with H after a hyphen (-) is assigned are for horizontal enlargement and reduction processing.

Matrix decomposition units 12_{-V} and 12_{-H} are configured like the matrix decomposition unit 12 in FIG. 6. In addition, although not shown here, it is preferable to provide the D-type flip-flops 13 and 14 for buffering shown in FIG. 6 in a post-stage of the matrix decomposition units 12_{-V} and 12_{-H}. Low-pass filters (LPF) 21_{-V}, 22_{-V}, and 23_{-H} and 24_{-H} are inserted in order to heighten a deterrent effect of folding noise.

A vertical oversampling circuit 25_{-V} oversamples pixel values of the 16 pixels “a” to “p”, which configure a unit matrix, 10 times. That is, the oversampling circuit 25_{-V} is configured of D-type flip-flops. Next, the pixel values of respective pixels “a” to “p” which are extracted by the matrix decomposition unit 12_{-V} and pass the LPF 21_{-V} are once held in the D-type flip-flops in accordance with a data clock ck2 (=ck0*sV*10=10ck1′) generated according to the vertical enlargement and reduction ratio sV, and are outputted in accordance with timing of the data clock ck2 in the 10 times of frequency concerned.

A horizontal oversampling circuit 26_{-H} oversamples pixel values of the 16 pixels “a” to “p”, which configure the unit matrix, 10 times. That is, the oversampling circuit 26_{-H} is configured of D-type flip-flops. Next, the pixel values of respective pixels “a” to “p” which are extracted by the matrix decomposition unit 12_{-H} and pass the LPF 23_{-H} are once held in the D-type flip-flops in accordance with a data clock ck3 (=ck1′*sH*10) generated according to the horizontal enlargement and reduction ratio sH, and are outputted in accordance with timing of the data clock ck3 in the 10 times of frequency concerned.

When the enlargement and reduction ratio sH or sV is restricted to a value of a single FIGURE below a decimal point, it becomes an integer by making this 10 times. Hence, it is possible to perform oversampling correctly by the oversampling circuits 25-V and 26-H only by delaying slightly phases of the oversampling data clocks ck2 and ck3. In addition, as mentioned above, configurations of the oversampling circuits 25_{-V} and 26_{-H} may be just configurations to hold the pixel values of the respective pixels “a” to “p” inputted in the D-type flip-flops in accordance with the data clocks ck2 and ck3.

Vertical coefficient RAM 4_{-V} stores coefficient values required for performing vertical enlargement and reduction. In addition, horizontal coefficient RAM 4_{-H} stores coefficient values required for performing horizontal enlargement and reduction. When the coefficient values stored in these two coefficient RAM 4 v and 4_{-H} are put together, it becomes the same as that of the coefficient values stored in the coefficient RAM 4 in FIG. 5.

A vertical coefficient multiplication unit 6_{-V} generates interpolation data at one vertical interpolation position by multiplying the pixel values of the respective pixels “a” to “p” outputted from the vertical oversampling circuit 25-V and the coefficient values read out from the vertical coefficient RAM 4_{-V} respectively, and adding all of those multiplication results. Three kinds of data clocks ck1′, ck2, and ck5 are used for this generation processing of interpolation data.

A horizontal coefficient multiplication unit 6_{-H} generates interpolation data at one horizontal interpolation position by multiplying the pixel values of the respective pixels “a” to “p” outputted from the horizontal oversampling circuit 25-H and the coefficient values read out from the horizontal coefficient RAM 4_{-H} respectively, and adding all of those multiplication results. One kind of data clock ck4 (=ck0*sV*sH=ck3/10) is used for this generation processing of interpolation data.

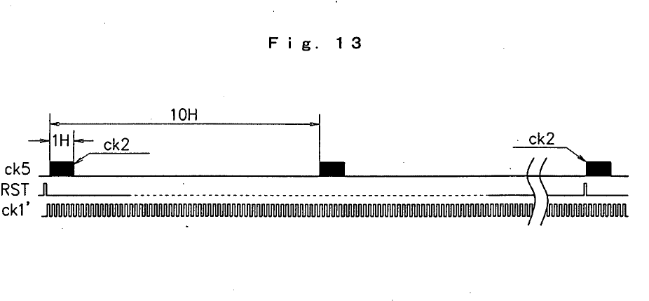

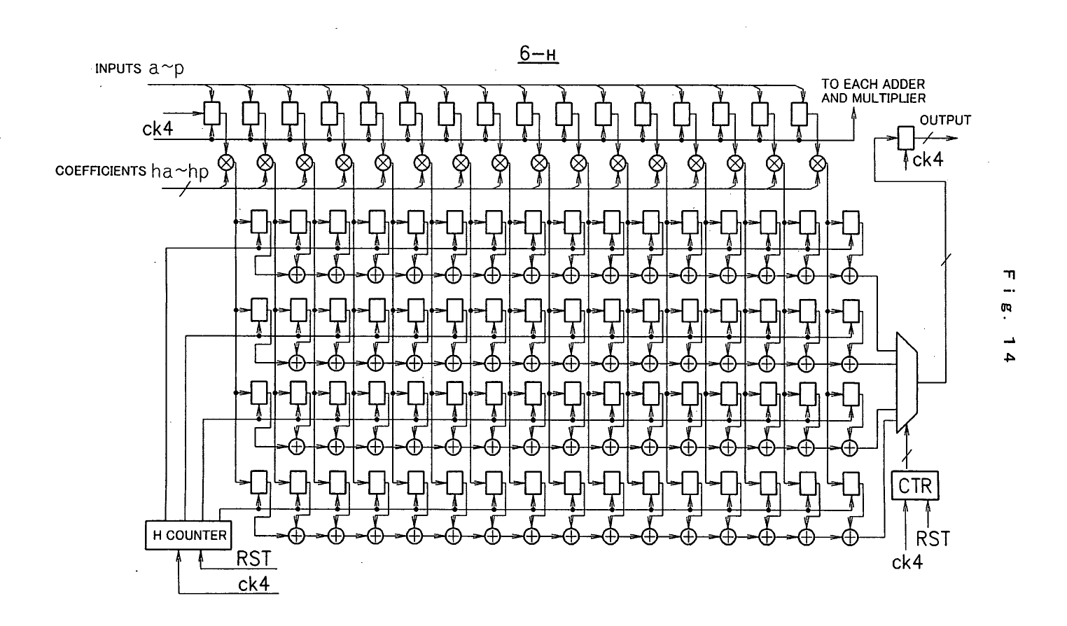

FIG. 12 is a diagram showing a configuration example of the vertical coefficient multiplication unit 6_{-V}. FIG. 13 is a timing chart showing data clocks ck1′, ck2, and ck5 which are used in this vertical coefficient multiplication unit 6_{-V}. In addition, FIG. 14 is a diagram showing a configuration example of the horizontal coefficient multiplication unit 6_{-H}. As shown in FIG. 13, the data clock ck5 is such a clock that the data clock ck2 is effective only during a first horizontal line period in the cycle concerned with making 10 horizontal lines, counted by the data clock ck1′, as one cycle.

In FIGS. 12 and 14, blocks shown by squares are D-type flip-flops for delay, blocks shown by × marks enclosed by rounds are coefficient multipliers, and blocks shown by +marks enclosed by rounds are adders. A CTR is a counter, and a block shown by a trapezoid is a selector. Similarly to the configuration of FIG. 10, also the configurations of FIGS. 12 and 14 achieve a faster real-time operation by performing product sum operations of the pixel values of the inputted pixels “a” to “p”, and coefficient values ha to hp, read out from the coefficient RAM 4, in accordance with the clocks cp1 to cp4 for pipelines by pipeline processing.

In addition, as shown in FIG. 12, since performing pipeline processing using the data clock ck5 as shown in FIG. 13, the vertical coefficient multiplication unit 6_{-V} can perform simultaneously the pipeline processing of multiplication and addition and the 1/10 thinning processing in a vertical direction. In addition, as shown in FIG. 14, since operating in accordance with the operation clock ck4 in 1/10 times of frequency of the operation clock ck3 of the horizontal oversampling circuit 26-H in a pre-stage of this, the horizontal coefficient multiplication unit 6_{-H} can perform simultaneously the pipeline processing of multiplication and addition and the thinning processing of 1/10 to a horizontal direction.

Although the screen enlargement and reduction devices according to the first to fourth embodiments described above show examples achieving these by hardware configurations, it is possible to achieve them also by any one of a DSP (Digital Signal Processor) and software. For example, when achieved by software, the screen enlargement and reduction devices according to the above-mentioned embodiments can be achieved by being configured of comprising a CPU or an MPU, RAM, ROM, etc. of a computer actually, and by operation of a program stored in the RAM or ROM.

Hence, the screen enlargement and reduction devices can be achieved by recording a program, which makes a computer operate so as to exert function of the above-mentioned embodiments, on a recording medium like CD-ROM, and making it read out by the computer. As recording media recording the above-mentioned program, it is possible to use, besides CD-ROM, a flexible disk, a hard disk, a magnetic tape, an optical disk, a magneto-optical disk, a DVD, a non-Volatile memory card, and the like. In addition, it is achievable also by downloading the above-mentioned program to a computer via networks, such as the Internet.

In addition, although RAM is used as memory to store coefficients beforehand, in the above-mentioned first to fourth embodiments, it is not limited to this. For example, ROM can also be used.

Furthermore, although the function like FIG. 4 is mentioned as an example of an interpolation function in the above-mentioned first to fourth embodiments, it is not limited to this. For example, such a function may be used (it is set so that the coefficient value may become a positive value when a spatial distance is larger than 0 and smaller than 1) that the coefficient value is 1 when the spatial distance between an interpolation position and an original pixel position is 0, and the coefficient value is converged at 0 when the spatial distance concerned is 1. Moreover, it is also sufficient to use such a function (it is set so that the coefficient value may become a positive value when a spatial distance is larger than 0 and smaller than 2) that the coefficient value is 1 when the spatial distance between an interpolation position and an original pixel position is 0, and the coefficient value is converged at 0 when the spatial distance concerned is 2.

In addition, in the above-mentioned first and second embodiments, although screen enlargement and reduction devices each also including the coefficient calculation unit 2 and function ROM 3 are configured, these may be another device. That is, the coefficient calculation device for arithmetically operating coefficients beforehand, and the screen enlargement and reduction device, which performs enlargement and reduction of an image using the coefficients beforehand obtained by the coefficient calculation device concerned may be configured as separate devices.

In this case, the coefficient calculation device includes, for example, the clock generation unit 1, coefficient calculation unit 2, and function ROM 3 shown in FIG. 1, and the screen enlargement and reduction device includes the clock generation unit 1, coefficient RAM 4, matrix decomposition unit 5, and coefficient multiplication unit 6. Incidentally, the third and fourth embodiments show configurations as the screen enlargement and reduction devices in each of which a coefficient calculation device is used as a different body and which performs enlargement and reduction of an image using coefficients beforehand obtained by the coefficient calculation device concerned.

In addition, the above-mentioned first to fourth embodiments are only what show specific examples at the time of implementing the present invention, and the technical scope of the present invention must not be restrictively interpreted by these. That is, the present invention can be implemented in various forms without deviating from its spirit or its main features.

### INDUSTRIAL APPLICABILITY

The present invention is useful to a device which performs enlargement and reduction of a digital image. The screen enlargement and reduction device of the present invention can be applied to enlargement and reduction of a still image and moving images.

1.-6. (canceled)

7. A screen enlargement and reduction device which performs enlargement and reduction of an image by obtaining a pixel value of each pixel at an interpolation position according to a predetermined magnification by an interpolation calculation from pixel values of an original image around the interpolation position about the original image configured of a plurality of pixels arranged at equal intervals on a two-dimensional space, comprising:
a coefficient calculation unit for obtaining a coefficient for a pixel value of each pixel of the original image around the interpolation position on the basis of a predetermined interpolation function for every interpolation position which is set according to the predetermined magnification;
a coefficient memory for storing the coefficient obtained by the coefficient calculation unit;
a matrix decomposition unit for extracting a pixel value of each pixel of the original image around the interpolation position;
a coefficient multiplication unit for obtaining a pixel value of each pixel at the interpolation position by multiplying/adding a pixel value of each pixel of the original image outputted from the matrix decomposition unit, and a coefficient read from the coefficient memory; and
a clock generation unit for generating a data clock which has predetermined times of frequency of the reference clock on the basis of the reference clock corresponding to a pixel interval of the original image, and the predetermined magnification, an adjustment data clock whose phase is shifted by a predetermined amount to the data clock, and another data clock which has a constant cycle and changes in timing different from a change of the adjustment data clock, and in that the matrix decomposition unit samples a pixel value of each pixel of the original image around the interpolation position in accordance with the adjustment data clock, thereafter resamples it in accordance with the another data clock, and extracts it.

8. The screen enlargement and reduction device according to claim 7,
the another data clock is an inverted data clock whose phase is inverted to the data clock; and
the matrix decomposition unit samples a pixel value of each pixel of the original image around the interpolation position in accordance with the adjustment data clock, thereafter resamples it in accordance with the inverted data clock, and extracts it.

9. The screen enlargement and reduction device according to claim 7,
the clock generation unit generates a clock, which delays by the predetermined amount than rise timing of the data clock, as the adjustment data clock when a phase of the data clock advances than central timing corresponding to just a center between a rise and a fall of the reference clock, and generates a clock, which advances by the predetermined amount than rise timing of the data clock, as the adjustment data clock when a phase of the data clock delays than the central timing of the reference clock.

10. The screen enlargement and reduction device according to claim 9,
the clock generation unit comprises a regulation circuit, a first AND gate, a second AND gate, and a third AND gate, and is made to generate the adjustment data clock by the regulation circuit and the first to third AND gates;
the regulation circuit is made not only to generate an advance clock whose phase advances by the predetermined amount to the data clock, and a delay clock whose phase delays by the predetermined amount to the data clock, to judge whether rise timing of the data clock advances or delays for a phase than the central timing of the reference clock, but also to generate a phase advance signal or a phase delay signal according to the judgment result; and
it is made so that the first AND gate takes and outputs AND of the advance clock and the phase delay signal, the second AND gate takes and outputs AND of the delay clock and the phase advance signal, and the third AND gate takes and outputs AND of an output of the first AND gate and an output of the second AND gate.

11. A screen enlargement and reduction device which performs enlargement and reduction of an image by obtaining a pixel value of each pixel at an interpolation position according to a predetermined magnification by an interpolation calculation from pixel values of an original image around the interpolation position about the original image configured of a plurality of pixels arranged at equal intervals on a two-dimensional space, comprising:
a coefficient memory for storing a coefficient for a pixel value of each pixel of the original image around the interpolation position, the coefficient being set for every interpolation position according to the predetermined magnification;
a matrix decomposition unit for extracting a pixel value of each pixel of the original image around the interpolation position;
a coefficient multiplication unit for obtaining a pixel value of each pixel at the interpolation position by multiplying/adding a pixel value of each pixel of the original image outputted from the matrix decomposition unit, and a coefficient read from the coefficient memory; and
a clock generation unit for generating a data clock which has predetermined times of frequency of the reference clock on the basis of the reference clock corresponding to a pixel interval of the original image, and the predetermined magnification, an adjustment data clock whose phase is shifted by a predetermined amount to the data clock, and inverted data clock whose phase is inverted to the data clock, and in that the matrix decomposition unit samples a pixel value of each pixel of the original image around the interpolation position in accordance with the adjustment data clock, thereafter resamples it in accordance with the inverted data clock, and extracts it.
